(19) United States
(12) Patent Application Publication
(10) Pub. No.: US 2016/0364726 A1
(43) Pub. Date: Dec. 15, 2016

(54) Systems and Methods for Use in Processing Transactions to Payment Accounts

(71) Applicant: MASTERCARD INTERNATIONAL INCORPORATED, Purchase, NY (US)

(72) Inventors: Ariel Lopez, Naucalpan de Juarez (MX); César Espinoza, Culiacan (MX); Carlos Zuluaga, Miami, FL (US)

(21) Appl. No.: 14/734,706

(22) Filed: Jun. 9, 2015

(51) Int. Cl. G06Q 20/40

(52) U.S. Cl. CPC G06Q 20/405

(57) ABSTRACT

Systems and methods are provided for processing transactions made at various merchants to payment accounts issued by other different merchants. One exemplary method generally includes receiving a charge request from a first merchant, relating to a transaction for a product at the first merchant between the first merchant and a consumer, where the charge request includes an identifier associated with a payment account used by the consumer in the transaction and issued by a second merchant. The method also generally includes determining, at a computing device, based on the identifier, a uniform account number (UAN) for the payment account where the UAN is unique to the payment account and defining a format different than a format of the identifier, and then causing, based on the determined UAN, a balance of the payment account to be altered.

### FIELD

The present disclosure generally relates to systems and methods for use in processing transactions to payment accounts, for example, issued by merchants and, more particularly, for use in processing transactions made at various merchants to payment accounts issued by other different merchants.

### BACKGROUND

This section provides background information related to the present disclosure which is not necessarily prior art.

Merchants often offer products (e.g., goods and services, etc.) for sale to consumers. Certain merchants are also known to offer merchant payment accounts, through which consumers may fund transactions with the merchants for products. The merchant payment accounts are particular to the issuing merchants, and typically are only usable for transactions made at the issuing merchants. Consumers, in certain instances, maintain multiple different merchant payment accounts, to fund purchases at the respective ones of the multiple different merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in processing transactions to payment accounts;

FIG. 2 is a block diagram of a computing device that may be used in the exemplary system of FIG. 1;

FIG. 3 is an exemplary method for use in processing at least one transaction to a merchant payment account, in connection with the system of FIG. 1; and

FIG. 4 is a diagram illustrating assignment of a uniform account number (UAN), based on an identifier associated with a merchant payment account.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

For ease of payment, merchants often provide (e.g., issue, etc.) payment accounts (i.e., merchant payment accounts) to consumers, whereby the consumers are able to transact with the merchants for products (e.g., goods and services, etc.) using funds in the merchant-issued accounts. The merchant payment accounts, such as, for example, toll payment accounts, are generally limited to the particular merchants that issued the accounts. As such, consumers that interact with multiple different merchants using such merchant payment accounts often carry multiple different payments devices (each associated with one of the multiple different merchants and their corresponding merchant payment accounts), in order to perform transactions at the different merchants. The networks and methods described herein cause transactions, using the merchant payment accounts, to be processed through a payment network. In particular, the payment network associates uniform account numbers (or UANs) with each of the merchant payment accounts, regardless of format of account numbers (broadly, identifiers) assigned to (or associated with) the payment accounts by the issuing merchants. Whether the accounts are managed by a service provider (i.e., not the issuing merchant) and/or by the issuing merchant, the UANs are then used within the payment network to process transactions from merchants to the appropriate payment accounts. In this manner, merchant payment accounts, and the existing payment devices associated with those accounts, may be used to purchase products from merchants other than the merchants who issued the merchant payment accounts.

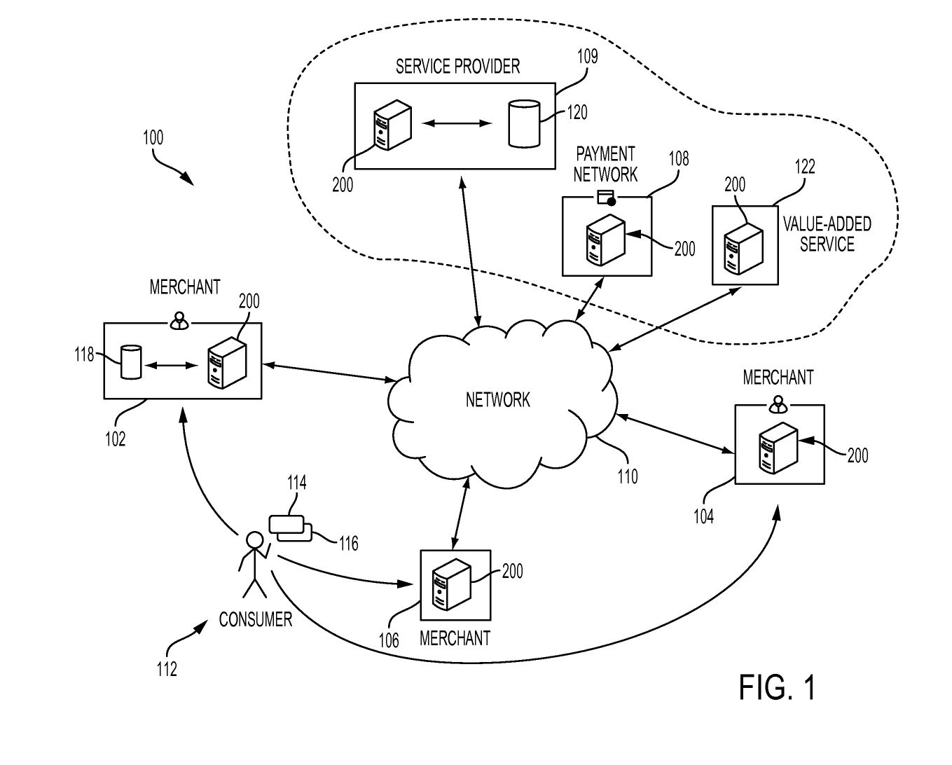

FIG. 1 illustrates an exemplary system 100, which can be used to process transactions among different merchants 102, 104, and 106. Merchants 102, 104, and 106 in the system 100 are each coupled to network 110. In addition, the system 100 includes a payment network 108, a service provider 109 and value added services (VAS) 122, which are also coupled to the network 110.

The merchants 102, 104 and 106 are coupled to the payment network 108 and/or service provider 109 through the network 110, or through one or more public and/or private networks separate from or part of the network 110, or through one or more intermediaries (e.g., third parties, etc.), etc., which may be distributed across a geographic region. Further, in the illustrated embodiment, the network 110 may include, without limitation, one or more local area networks (LAN), wide area networks (WAN) (e.g., the Internet, etc.), mobile networks, other networks as described herein, and/or other suitable public and/or private networks capable of supporting communication between the merchants 102, 104, and 106 and the payment network 108 and the service provider 109. In one example, the network 110 includes multiple networks, where different ones of the multiple networks are accessible to different ones of the merchants in FIG. 1.

Further, VAS 122 may be integrated, in whole or in part (by one or more services, for example), with the payment network 108 and/or the service provider 109, through network 110 to provide services to all transactions processed within system 100.

Each of the merchants 102, 104 and 106 in the system 100 primarily offer products for sale to consumers (e.g., consumer 112 in FIG. 1, etc.). In the illustrated system 100, for example, the merchants 102, 104, and 106 are toll operators, who provide access to toll roads, bridges, etc., in exchange for payment from the consumer 112 (and from other consumers). With that said, it should be appreciated that the merchants 102, 104, and 106 may offer any number of products, whether the same products, similar products, and/or different products, for purchase to the consumer 112. The products may include, for example, any desired goods, services, etc. (and which need not be limited to toll services, parking services, transportation services/accesses (e.g., subway, bicycle, bus, etc.), but may include any retail goods/services, either related or unrelated to transit and/or transportation).

Further, while only three merchants 102, 104, and 106 and one consumer 112 are illustrated in FIG. 1, it should be appreciated that any number of merchants and/or consumers may be included in and/or supported by the system 100 in various other embodiments. Further, it should be understood that in some embodiments, as indicated by the dotted line, the payment network 108, the service provider 109, and/or the VAS 122 may be integrated. In other system embodiments, two of the payment network 108, the service provider 109, and/or the VAS 122 may be integrated, while the other remains separate. When not integrated, the service provider 109 communicates indirectly with the payment network 108 and/or the VAS 122, via network 110, or vice-versa. Further the payment network 108 may communicate indirectly with the VAS 122, via network 110.

Referring still to FIG. 1, in the system 100, the merchants 102 and 106 both offer merchant-issued payment accounts (i.e., merchant payment accounts) to consumers, including the consumer 112. The merchant payment accounts are directly issued by the particular merchants 102 and 106. Through the merchant payment accounts issued by merchants 102 and 106, the consumer 112 is able to complete transactions for products at the merchants 102, 104 and 106, respectively, using funds previously loaded to the consumer's corresponding merchant payment account. Conversely, in the system 100, the merchant 104 does not offer merchant payment accounts to its consumers (e.g., consumer 112, etc.).

Payment devices 114 and 116 are associated with the merchant payment accounts issued by merchants 102 and 106, and may be branded by the particular merchants 102 and 106 issuing the corresponding merchant payment accounts (or branded by a payment network or service provider (e.g., the service provider 109, etc.) involved in transactions to the accounts). In particular, the payment device 114 is associated with a merchant payment account issued by the merchant 102, and the payment device 116 is associated with a merchant payment account issued by the merchant 106. Example payment devices include, without limitation, payment cards, toll tags, vehicle tags, vehicle transponders/transmitters, fobs, smartphones/tablets with transaction-enabled applications, etc.

In some aspects, the merchant payment accounts are provided by the merchants 102 and 106 as pre-paid or debit accounts, in which funds are loaded into the payment accounts by the consumer 112 in advance and then used by the consumer 112, via the payment devices 114 and 116, for example, to make purchases (e.g., at the merchants 102 or 106 issuing the particular payment accounts, or at other merchants (e.g., merchant 104, etc.) as facilitated by the payment network 108 provided herein, etc.). As such, when the merchant payment accounts are without funds, or have insufficient funds, they are not usable to fund the transactions. However, in other aspects, the merchant payment accounts are provided by the merchants 102 and 106 as credit or similar type accounts, or hybrid credit-prepaid/debit accounts, by which transactions are completed, at least in part, based on credit.

In addition, the merchant payment accounts available from the merchants 102 and 106 are each generally associated with a 12-digit hexadecimal identifier, which may, in various embodiments, follow specific industry standards. The identifier includes a segment or digit(s) indicative of the merchant (i.e., a merchant identifier/ID) and a segment or digit(s) indicative of the consumer (i.e., a consumer identifier/ID). While reference is made to a 12-digit hexadecimal identifier, it should be appreciated that this is only one example format and that any different formats of identifiers (e.g., number of digits, type of digits (e.g., numeric, alphabetic, or alpha-numeric, special characters, etc.), etc.) may be selected and used by merchants 102 and 106, to identify their accounts.

Uniquely in the system embodiment of FIG. 1, the consumer 112 can transact with any of the merchants 102, 104, and 106 using the payment account provided by the merchant 102 or the payment account provided by the merchant 106. The transactions made by the consumer 112 at the merchants 102, using the corresponding merchant payment account 114, can be processed either directly by the merchants 102, or separately by the payment network 108, in order to, for example, use the VAS 122. In various embodiments, the particular manner in which the transactions are processed depends on the configurations and/or preferences of the merchants 102 and 106, i.e., issuing merchants. In particular, as described below, transactions may be handled differently when an issuing merchant elects to manage transactions to its merchant payment accounts, like merchant 102, as compared to when the issuing merchant elects for the service provider 109 to manage transactions to the merchant's payment accounts, like merchant 106.

In general, upon receipt of the charge request, from a merchant, the payment network 108 and/or service provider 109 determines (e.g., calculates, assigns, retrieves, etc.) a uniform account number (UAN) based on an identifier for the merchant payment account (included in the charge request), alone, or in combination with other information, as described with reference to method 300 below.

In a first example, in connection with a transaction at the merchant 104 using the merchant payment account issued by the merchant 106, the consumer 112 initially presents the payment device 116 to the merchant 104. In turn, the merchant 104 receives, reads, and/or scans the payment device 116 to collect information necessary (and possibly additional information) to initially identify the consumer's payment account (e.g., by a computing device associated with the merchant 104, such as a POS device, etc.). In the example system 100, the merchant 104 may scan a vehicle tag, as the vehicle passes within the vicinity (i.e., sufficiently close to permit scanning and/or reading the vehicle tag, etc.) of a toll road, bridge, and/or booth (e.g., a toll booth operated by the merchant 104, etc.), to determine an identifier associated with the vehicle tag. The merchant 104 then transmits a charge request to the payment network 108, which determines the UAN and routes the transaction to the service provider 109 to process the transaction.

In turn, the service provider 109 processes the transaction, and returns an approved or declined indication to the merchant 104, and directly alters the balance associated with the payment account. In particular, while the merchant 106 may maintain a particular listing (or database) of merchant payment accounts issued (e.g., stored in a computing device associated with the merchant 106, etc.) (and other data related to the payment accounts), the merchant 106 relies on the service provider 109 to manage transactions to its merchant payment accounts. Specifically, in this example, the service provider 109 maintains the funds to/from the payment accounts in a database 120 and thus, manages the transactions through the database 120. The merchant 106 thus is able to offer and issue payment accounts to its consumers, such as consumer 112, but is not required to handle management of transactions, including transactions to its payment account, at merchant 106 or other merchants, such as merchants 102 and 104. The merchant 106 may, in some embodiments, communicate directly with the service provider 109 regarding transaction data, including, for example, payment account balances, etc.

It should be appreciated that the database 120, while illustrated as a single database, included in the service provider 109, it may include multiple databases distributed over a geographic region

In a second example, in connection with a transaction at the merchant 104 using the merchant payment account issued by the merchant 102, the merchant 104 reads or scans the payment device and transmits the charge to the payment network 108, which in turn, determines the UAN, and further invokes VAS 122, as desired or necessary. And then, the payment network 108 routes the transaction to merchant 102. The merchant 102, as shown in FIG. 1, includes database 118, which is employed, by the merchant 102, to maintain the merchant payment accounts that it provides. Beyond merely issuing, revoking, and/or maintaining the payment accounts, the merchant 102 also manages the funds paid into and/or debited from the payment accounts. As such, the merchant 102 may process the transaction (in response to the charge request), via the database 118, and return an approved or declined indication to the merchant 106, via the payment network 108, and further alter the balance associated with the payment account (when the transaction is approved).

In a third example, when the transacting merchant is the merchant 102, and issuing merchant is also the merchant 102, the merchant 102 may complete the transaction, in database 118, for example, without involvement of the payment network 108, nor the service provider 109, nor VAS 122. In multiple embodiments, however, the merchant 102 may still involve the payment network 108, as if the transacting merchant was different, in order to utilize one or more value-added services, enabled by involvement of the payment network 108 and the VAS 122, as described below.

The payment network 108, in numerous embodiments, coordinates clearing and settlement among the merchants 102, 104, and 106. As such, the payment network 108, for example, may determine net positions, assess fees associated with interchange and/or value-added services (via VAS 122), manage currency exchanges, coordinate with and among settlement agents for the merchants, coordinate terms of settlement (e.g., timing, etc.), etc. Various other operations and/or steps may be performed by the payment network 108 to facilitate the processing and/or completion of transactions to merchant payment accounts, at merchants other than the issuing merchant.

In various embodiments, as shown in FIG. 1, the VAS 122 optionally provides additional value-added services for one or more transactions processed through the payment network 108, including, without limitation, fraud protection, stand-in service, information management services, transaction filters (e.g., based on account number, transactions, amount, location, etc.), e-mail or SMS notifications, white lists (e.g., including preferred or VIP customers, accounts, etc.), and black lists (e.g., lost/stolen accounts or account status, etc.), etc. Implementation of one or more of these services may cause the payment network 108, and/or the VAS 122, to transmit one or more different types of information to the merchants 102, 104, and 106, to groups of consumers to which the merchants 102 and 106 issued payment accounts, to individual consumers to which the merchants 102 and 106 issued payment accounts, etc. The format and/or timing of transmission of the information may be dependent on the type of information. For example, fraud detection information/reporting may be provided, from VAS 122, to the merchants 102, 104, and/or 106 promptly or immediately, while analytics reporting may be periodically (e.g., weekly, monthly, quarterly, etc.), or upon demand.

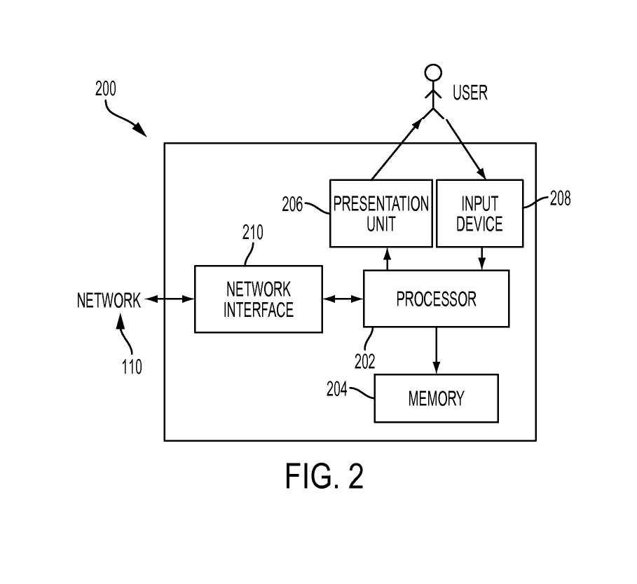

As shown in FIG. 1, the merchants 102, 104 and 106, the payment network 108, service provider 109, and the VAS 122 are each associated with one or more computing devices, such as, the exemplary computing device 200, shown in FIG. 2. With that said, all components mentioned above should not be understood to be limited to the computing device 200 illustrated in FIG. 2, as multiple similar or different computing devices, located together or distributed across a geographical region, may be employed as one or more of the merchants 102, 104, and 106, the payment network 108, the service provider 109, the VAS 122, etc.

By way of example (and without limitation), the exemplary computing device 200 may include one or more servers, workstations, computers, laptops, tablets, PDAs, telephones (e.g., cellular phones, smartphones, other phones, etc.), POS devices, combinations thereof, etc., as appropriate.

With reference to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, transaction data, including account identifiers, merchant payment accounts, merchant identifiers, transaction data, information management services reports, clearing and/or settlement records, algorithms, and/or any other types of data suitable for use as described herein, etc.

Furthermore, in various embodiments, computer-executable instructions may be stored in the memory 204 for execution by the processor 202 to cause the processor 202 to perform one or more of the functions described herein (e.g., method 300, etc.), such that the memory 204 is a physical, tangible, and non-transitory computer-readable storage media. It should be appreciated that the memory 204 may include a variety of different memories, each implemented in one or more of the functions described herein.

The illustrated computing device 200 also includes a presentation unit 206 that is coupled to the processor 202. The presentation unit 206 outputs, or presents, to a user (e.g., individuals associated with one or more of the service providers in the system 100; etc.) by, for example, displaying, audibilizing, and/or otherwise outputting information such as, but not limited to, information relating to transactions for products (e.g., goods and/or services, etc.), and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

Finally, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 110. In some exemplary embodiments, the computing device 200 includes the processor 202 and one or more network interfaces incorporated into or with the processor 202.

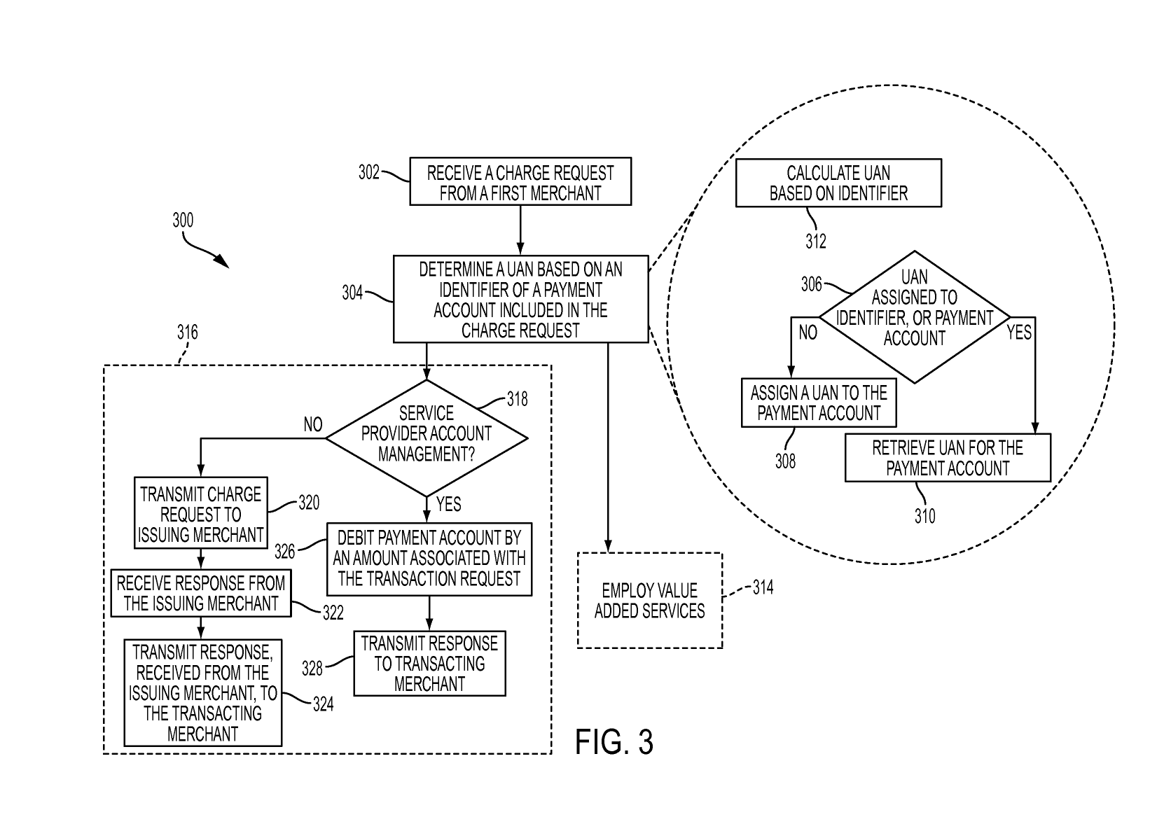

FIG. 3 illustrates an exemplary method 300 for use in processing at least one transaction to a merchant payment account, for example, a transaction in the system 100 performed by the consumer 112 at the merchant 106 using a payment account issued by either the merchant 102 or the merchant 104. Method 300 is described herein with reference to the system 100 and computing device 200, for illustration. However, the method 300 could be implemented in one or more different networks, and/or computing devices, in other embodiments. Likewise, the networks and computing devices herein should not be understood to be limited to the exemplary method 300.

Further, while any merchant (e.g., any of the merchants 102, 104, and 106 in the system 100, or any other merchants, etc.) may transmit a charge request to the service provider 109 or other merchant in the system 100, the method 300 is described with reference to the consumer's attempt to complete a transaction at merchant 106, using a payment account issued by the merchant 102. In addition in the method 300, the merchants 102 and 106 are both toll merchants that offer access to certain roads, bridges, etc., or to other transportation, in exchange for payment. It should be appreciated, however, that variations in the method 300 may exist when different merchants, whether illustrated in FIG. 1 or not, and others, are the transaction merchant, that offer the same, similar, and/or different product (e.g., goods or services, etc.) for purchase, etc., and/or are the issuing merchant.

As shown in FIG. 3, in connection with a transaction by the consumer 112 at the merchant 106, the payment network 108, receives, at 302, via computing device 200 (and network 110), a charge request for the transaction from the merchant 106. In this exemplary embodiment, charge requests will be provided according to one or more interchange message specifications, such as for example, the ISO standard, and in particular, including 0200/0210 ISO 8583 messages, and/or similar or different message formats. Generally, the charge request conforms to a particular format (whether globally or specific to the merchant), whereby the charge request may be properly interpreted by the payment network 108.

The charge request, in the illustrated method 300, includes an identifier of a merchant payment account, issued to the consumer 112 by the merchant 102. The identifier may include, without limitation, an account number for the payment account (or consumer identifier/ID), an identifier/ID of the merchant 102, and other desired information. In addition to the identifier, the charge request may further include, without limitation, an identifier/ID of the issuing merchant 102, a charge amount of the transaction, a temporal indicator (e.g., a time/date of the transaction, etc.), an identifier/ID of the transacting merchant (e.g., merchant 106, etc.) and/or other information useable in processing the transaction, or otherwise. With that said, it should be appreciated that the information included in the charge request may be different depending on, for example, the type/number of transacting merchant, the type/number of issuing merchant, the products available for purchase and/or the associated charge amounts from the transacting merchants, etc.

Upon receipt of the charge request, the payment network 108, determines, at 304, via computing device 200, a uniform account number (UAN) based on the identifier for the merchant payment account in the request.

In the illustrated method 300, in certain examples, determining the UAN generally may include determining, at 306, by the payment network 108, if a UAN has previously been assigned to the identifier (and/or payment account) (as indicated by recognition of the identifier by the payment network 108). If a UAN has not previously been assigned to the identifier and/or merchant payment account (or issuing merchant), the payment network 108 assigns a new, original UAN to the charge request and/or identifier included therein (i.e., to the merchant payment account), at 308, from one or more lists of available UANs, or a next available UAN (e.g., for the merchant, etc.), thereby determining the UAN. Generally, the assigned UAN will include a prefix, or first segment, indicative of the issuing merchant (e.g., assigned, or calculated based on an identifier/ID for the merchant, etc.) (referred to below as a MIN (i.e., merchant identification number)). The payment network 108 then stores the assigned UAN in memory (e.g., in memory 204 of the computing device 200 associated with the service provider 109, in the database 120, etc.), in association with the identifier and/or other information identifying the associated merchant payment account and/or consumer.

With continued reference to FIG. 3, if the payment network 108 determines, at 306, again via computing device 200, that the payment account has previously been assigned a UAN, the payment network 108 retrieves, at 310, the UAN from memory (e.g., from memory 204 of the computing device 200 associated with the payment network 108, from the database 120, etc.). The retrieved UAN is then the determined UAN, at 304.

Alternatively, in this exemplary embodiment, the payment network 108 may determine the UAN in a different manner. As shown in FIG. 3, the payment network 108 may calculate the UAN, at 312, based on at least the identifier/ID of the merchant payment account. Specifically, the payment network 108 calculates a MIN, based on, for example, an identifier/ID for the merchant, which may be a part of the identifier included in the request, or separate therefrom. The payment network 108 further calculates the next segment of the UAN (or part of the UAN) based on the identifier/ID included in the charge request. Finally, a check digit is included, sufficient to validate the UAN according to one or more standards. It should be appreciated that a variety of different algorithms may be employed to ensure that each different identifier yields a different UAN, or part of the UAN. By calculating the UAN in this or other manners, the payment network 108 is able to calculate the same UAN, or part thereof for each transaction request including the same identifier of the merchant payment account (without having to assign the UAN and then later retrieve the entire UAN from memory 204, or store the entire UAN in memory 204).

In one or more embodiments, the payment network 108 may employ a combination of retrieving from memory 204, at 310, and calculating based on the identifier or otherwise, at 312, in order to determine the UAN.

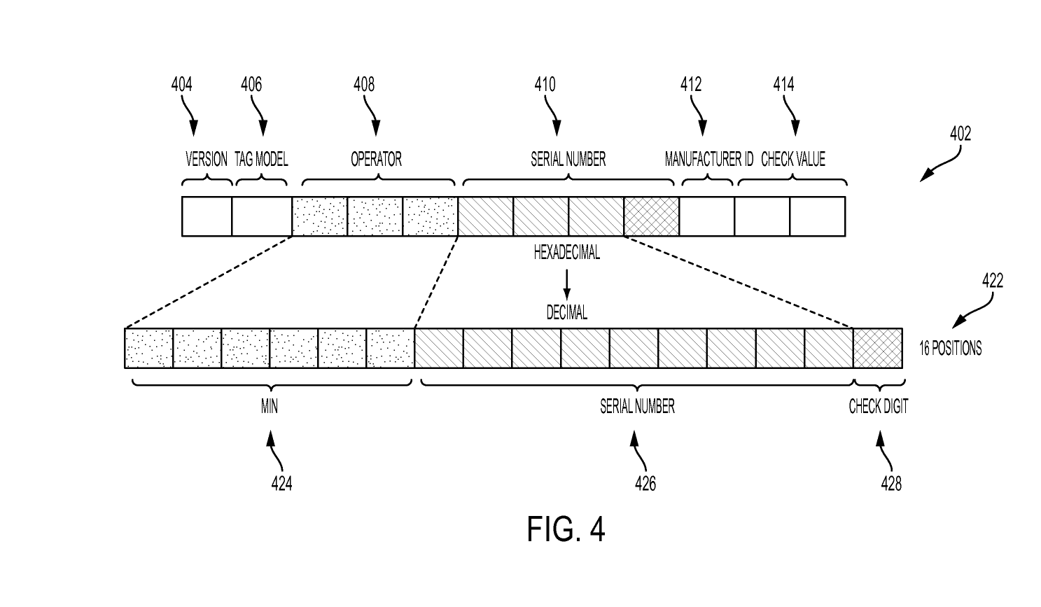

FIG. 4 illustrates an example identifier 402 that may be associated with the merchant payment account, and included in the charge request received by the payment network 108, in method 300. The example identifier 402 includes a version indicator 404, a model indicator 406 for the payment device used in connection with the merchant payment account (e.g., a toll tag, etc.), an operator indicator 408 corresponding to the issuing merchant 102, and a serial number 410 that is indicative of the particular consumer 112, i.e., the particular customer payment account. The example identifier 402 also includes manufacturer identification 412 and a check value 414.

FIG. 4 also illustrates an example UAN 422 that can be calculated (broadly, determined) for the merchant payment account (issued by merchant 102) in method 300, for example, based on the identifier 402. In order to determine the UAN 422 to the merchant payment account, the payment network 108 initially recognizes a format of the identifier 402 (e.g., from the charge request in method 300, etc.), and extracts the operator indicator 408 therefrom (i.e., the segment that is the merchant identifier/ID for merchant 102). The payment network 108 then calculates a first segment, including 6-digits (i.e., MIN 424 in FIG. 4), of the UAN 422, using one or more algorithms (whereby the MIN is unique and always the same, if recalculated). Next, the payment network 108 identifies the consumer-specific serial number 410 from the identifier 402 (i.e., consumer identifier/ID) and calculates a second segment, including, for example, 9-digits (i.e., serial number 426 in FIG. 4), of the UAN 422, using one or more algorithms (again, whereby the serial number is unique and always the same, if recalculated), which, in this example, includes conversion from hexadecimal to decimal. Finally, the payment network 108 calculates a check digit 428 of the UAN 422, which is used by whatever part of the system 100, and/or third parties, as needed, to validate the UAN.

Conversely, in FIG. 4, the UAN, or parts thereof, may be assigned or retrieved from memory (e.g., memory 204), rather than calculated, as described above. For example, the payment network 108 may retrieve a previously assigned first segment for the merchant 102 (i.e., as the MIN 424 in FIG. 4) and assigns it to the first segment of the UAN 422. The payment network 108 may then further assign the serial number 426 specific to the consumer, and then assign or calculate the check digit 428.

Notwithstanding the exemplary format in FIG. 4, it should be appreciated that the identifier and/or the UAN may include a variety of different formats. The number of digits (or positions) may be different, and/or the type of digits may be different, and/or the arrangement of digits may be different.

For example, in FIG. 4, the identifier 402 is a 12-digit hexadecimal, and the UAN 422 is a16-digit decimal. However, in other examples, identifiers may have more than or fewer than twelve digits, and may include a different type of digits (e.g., numeric, alphabetic, or alpha-numeric, special characters, etc.). Similarly, in other examples, UANs may have more than or fewer than sixteen digits (e.g., eighteen digits, nineteen digits, etc.), and may include a different type of digits. Moreover, a different number of digits, or types of digits, within the UAN and/or identifier, may be indicative of the issuing merchant, the particular payment account, or other information, etc. For example, the number of digits in the MIN may be 4 digits, or another number of digits, potentially dependent of prior associated identifier, or standard formats within a particular product area (e.g., toll operator, etc.). Generally, the number and type of digits included in the identifiers and/or the UANs provides a number of possible unique identifiers and/or UANs that may be constructed. The format is thus often selected based on the expected number of consumers and/or merchants to be included in (or that will use) the given payment network, and/or one of more other factors, including, for example, the type of payment devices employed by the merchants in the given payment network (e.g., tags, cards, fobs, smartphone applications, etc.), POS devices at the merchants, security, consumer preferences, etc.

With reference again to FIG. 3, once the UAN is determined at 304, the payment network 108 optionally employs (as indicated by the broken lines) value-added services, by invoking and/or communicating with the VAS 122, at 314, for the requested transaction and/or the merchant payment account identified in the charge request and used for the transaction.

For example, in some embodiments, the payment network 108 may employ, via VAS 122, one or more fraud protection measures, based on transaction data for the merchant payment account (e.g., pattern recognition for transactions made using the merchant payment account, abnormal transaction identification for the merchant payment account, etc.), etc. In addition, in certain embodiments, where the merchant 102, for example, is managing the merchant payment account, or further where the payment network 108 merely receives and/or passes through charge requests, the payment network 108 and/or the service provider 109 causes stand-in services (i.e., a value-added service) to be provided, via the VAS 122, to authorize transactions to the merchant payment account based on, for example, black/white lists, risk parameters, etc., when the merchant 102 is unable or unavailable to respond, directly, to the charge request. As used herein, value-added services may further include dispute resolution services for charges to the merchant payment account, whereby the payment network 108 and/or the service provider 109 receives, manages, and processes any disputes relating to the merchant payment account, which may ultimately result in chargebacks, adjustments, retrievals, etc., to/from the merchant payment account. As part of these dispute resolution services, the payment network 108 and/or the service provider 109 may further provide image handling, etc. In some embodiments, merchants may define one or more dispute resolution rules, including, for example, documentation requirements (e.g., customer letter, merchant letters, reports, logs, etc.). In such embodiments, the VAS 122 may provide an imaging platform (via payment network 108, or separately) where merchants may transmit the required documents (or other documents) in a secure, standard, reliable medium, thereby inhibiting the tampering/modification of the documentation.

Additionally, in various embodiments, as part of method 300, the payment network 108 and/or the service provider 109 may further cause information management services (i.e., an exemplary value-added service) to be provided, via VAS 122. The information management services may be related to the merchant payment account included in the charge request or to other merchant payment accounts or groups of merchant payment accounts, and/or reporting of such information in a variety of forms. For example, the VAS 122 may provide customized reports for particular ones of the merchants 102, 104, and 106 in the system 100, for example, based on whether or not the particular ones of the merchants 102, 104, and 106, or the service provider 109, manages balances of the merchant payment account. Reports may include a variety of different analytics on the information available to the payment network 108 and/or the service provider 109, and provided in a form desirable and/or usable to the merchants 102, 104, and 106 and/or the consumer 112. In several examples, the VAS 122 provides applications and/or websites, hosted by or interacting with computing device 200, through which interfaces are presented to the consumer 112, and/or the merchants 102, 104, and 106, may load funds to a payment account, check balances, and/or other account operations, etc.

Additionally, certain reports may include notifications for abnormal transactions made to the merchant payment account, fraud markers for transactions made to the merchant payment account, and/or other information of interest. Further, the reports may be provided, by the VAS 122 (e.g., via payment network 108 and/or the service provider 109, etc.), to the merchants 102, 104, and 106, or to the consumer 112, in some embodiments, as statements of the particular merchant payment account, transaction histories for the merchant payment account, summaries of various data associated with the merchant payment account, etc.

And, certain reports of transmission from the payment network 108 and/or the service provider 109 to the merchant, such as merchant 102 or merchant 106, may be more specific to individual transactions. For example, the service provider 109, or VAS 122, may provide balance updates, or balance summaries to the merchant 106, or merchant 102 (even if the service provider is not managing the account) at predetermined times (e.g., within 1 minute of a transaction, daily, weekly, etc.), or upon request from the merchant. Such balance information may be used, in some examples, to manage the balance of the payment account.

Generally, reporting provided from the service provider 109 or VAS 122 (if separate) may be customize to any different parameters, formats, schedules, etc., provided by the merchants 102, 104, and/or 106.

In at least one embodiment, in the method 300, the merchant 102 opts out of value added services, whereby the payment network 108 may act to merely process transactions made using the payment account issued by the merchant 102.

Next in the method 300, the payment network 108 receives a charge request from any merchant which can be connected directly to the network 110, like merchant 102 or 104, or through the service provider 109, like merchant 106. If the issuing merchant is merchant 106, the payment network 108, after determining the UAN, as described above, causes the payment account to be altered, at 316, which may be directly, or indirectly, depending on the management of the payment accounts. In particular, the payment network 108 determines, at 318, via computing device 200, whether the merchant payment account identified in the charge request is being managed by the service provider 109, or by the merchant 102 that issued the account. As described in connection with the system 100, the merchant 102 has opted to manage the merchant payment account. Thus, for issuing merchant 102, the payment network 108 determines, at 318, that the merchant payment account is merchant-managed (and thus is not being managed by a service provider 109), and transmits, at 320, the charge request to the merchant 102. In this embodiment, the charge request includes the identifier, whereby the merchant 102 is able to readily recognize the identifier and process the charge request accordingly. In one or more embodiments, the payment network 108 may include a UAN (if assigned) for the merchant payment account in the charge request, even when the issuing merchant manages the transactions, for one or more reasons.

Upon receiving the charge request from the payment network 108, the merchant 102 checks the balance of the merchant payment account identified therein (e.g., in database 118, etc.) and compares it to the charge amount indicated in the charge request. If sufficient funds are present in the merchant payment account, the merchant 102 returns an approval of the transaction (or authorization response) to the network 110, which is received by the payment network 108, at 322. And, the merchant 102 then debits the merchant payment account by the transaction amount. In turn, the payment network 108 transmits the approval (or authorization response), at 324, to the merchant 106, so that the transaction can be completed.

The transaction amount may be specifically identified in the charge request, as a fixed amount, or the transaction amount may be a variable amount. The latter variable amount is provided for authorization of an undetermined transaction amount such as, for example, a purchase of petrol before actually filling a vehicle tank. In such instances, the merchant 102 (or the service provider 109, as described below) provides approval to the merchant 106 for the transaction based on a pre-authorization amount. More specifically, in response to a charge request from merchant 104, for example, the payment network 108 may provide a pre-authorization and a maximum amount possible for the product to the merchant 102. The merchant 102, in response, may immediately debit the pre-authorization amount, or a different transaction amount from the merchant payment account. Alternatively, the merchant 102 identifies the charge as a pre-authorization request and during clearing (as described below) processes the final correct amount, adjusting the merchant payment account accordingly. If, however, insufficient funds are present to complete the transaction, or are less than the predetermined variable amount, the merchant 102 may return a declined response to the payment network 108 (e.g., at operation 322, etc.). And, the payment network 108 then relays the declined response back to the merchant 106 (e.g., at operation 324, etc.).

Alternatively in the method 300, for the merchant payment account issued by the merchant 106, the payment network 108 determines, at 318, that the merchant payment account is managed by the service provider 109, and provides the charge request to the service provider 109 (e.g., transmits the charge request if the service provider 109 is separate, etc.). The service provider 109, in turn, determines if the transaction should be approved or denied. If the transaction is approved, the service provider 109 debits the transaction amount from the merchant payment account, at 326, and returns an approval response, at 328, to the merchant 106, via the payment network 108.

The payment network 108 further provides clearing and settlement, of accounts, in this embodiment, whether managed by the service provider 109 or the merchant 102 (or other merchants). In various embodiments, in clearing the transactions, the payment network 108 calculates the net position for each of merchants 102, 104, and 106. Often, as part of the net position, or separately, the payment network 108 calculates fees associated with use of the payment network 108, the service provider 109, and/or VAS 122, based on, for example, the involvement of the payment network 108 in processing the transactions (e.g., managing accounts, not managing accounts, value added services, etc.). The fees may be applied specifically to individual merchants, or more generally, to a group of merchants. Clearing, by the payment network 108, may further include managing currency conversions, where applicable. For example, when charges in one region/country are presented in one currency, and the merchant payment account is managed in another currency (in a different region/country), conversions may be provided by the payment network 108. Additionally, in several embodiments, the payment network 108 further provides reconciliation reports and net positions, to the merchants 102, 104, and 106, via, for example, web services, e-mail, computer, etc.

In addition to clearing, the payment network 108 may, in certain embodiments, offer settlement of charges between the various merchants. In particular, the payment network 108 may coordinate settlement agents for the merchants 102, 104, and 106 (often selected by the merchants) and/or for the different currencies (where multiple currencies are to be exchanged). The settlement agents are provided with received net settlement instructions, by the payment network 108, and the merchants 102, 104, and 106 (and other merchants) which will settle through the settlement agents. The payment network 108 further may define, on-behalf of the merchants 102, 104, and 106 (and other merchants), a settlement delay (e.g., today plus 1 day, 2 days, 5 days, etc.), to help to ensure that charges are posted and/or undisputed prior to payment. It should be understood that the payment network 108 may provide these and/or other operations and/or functions as useful to the methods and systems herein described.

Consistent with the above, different merchant payment accounts may be used for transactions at merchants other than the issuing merchants of the accounts. Also, in numerous embodiments, consumers are able to maintain their payment devices (associated with the merchant payment accounts) because a common payment network 108 makes the identifiers associated with the payment accounts (regardless of format and/or payment device) uniform to a single format selected by the payment network 108. The payment network 108 is thus able to provide processing to the merchants, with minimal or no impact to the payment accounts and/or payment devices already issued by the merchants, for example, whereby the merchants are able to continue processing certain transactions directly (if desired).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a charge request for a product from the first merchant, the charge request including an identifier associated with the payment account issued by the second merchant; (b) determining, based on the identifier, a uniform account number (UAN) for the payment account, the UAN being unique to the payment account and defining a format different than a format of the identifier; (c) causing, based on the determined UAN, a balance of the payment account to be altered; and/or any of the method steps or processes described or claimed herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various merchant, segments, transactions, etc., these elements should not be limited by these terms. These terms may be only used to distinguish one element from another. Terms such as “first,” “second,” and other numerical terms when used herein do not imply a sequence or order unless clearly indicated by the context. Thus, a first element discussed could be termed a second element without departing from the teachings of the example embodiments.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in processing at least one transaction, between a consumer and a first merchant, to a payment account issued by a second merchant, the method comprising:
receiving a charge request for a product from the first merchant, the charge request including an identifier associated with the payment account issued by the second merchant;
determining, at a computing device, based on the identifier, a uniform account number (UAN) for the payment account, the UAN being unique to the payment account and defining a format different than a format of the identifier; and
causing, based on the determined UAN, a balance of the payment account to be altered.

2. The method of claim 1, wherein determining the UAN based on the identifier includes calculating at least part of the UAN based on the identifier.

3. The method of claim 1, wherein determining the UAN based on the identifier includes retrieving at least part of the UAN from memory, based on the identifier.

4. The method of claim 1, wherein a format of the identifier includes from 8 to 15 hexadecimal or decimal digits; and/or
wherein a format of the UAN includes at least 10 hexadecimal or decimal digits.

5. The method of claim 1, wherein causing the balance to be altered includes:
identifying an amount indicated in the charge request;
identifying the payment account associated with the UAN; and
debiting the amount from the payment account.

6. The method of claim 1, wherein causing the balance to be altered includes transmitting the charge request to the second merchant.

7. The method of claim 1, wherein the first merchant and the second merchant are the same merchant.

8. The method of claim 1, wherein causing the balance to be altered includes causing the balance to be altered by one of: an amount of the at least one transaction and a pre-authorization amount associated with the at least one transaction.

9. The method of claim 1, further comprising transmitting a balance summary to the second merchant, at one of a predetermined time and upon request from the second merchant.

10. A system for processing at least one transaction, between a consumer and a first merchant, to a payment account issued by a second merchant, the system comprising:
a payment network including a memory and configured to:
receive a charge request for a transaction to a payment account issued by a first merchant, the charge request including an identifier of the payment account and a charge amount;
in response to the charge request, calculate at least part of a UAN, based on the identifier; and
debit the charge amount from the payment account associated with the UAN.

11. The system of claim 10, wherein the payment network, in order to calculate at least a part of the UAN, is configure to:
calculate a serial number of the UAN based on a consumer identifier/ID included in the identifier; and
calculate a MIN of the UAN based on a merchant identifier/ID for the first merchant included in the identifier.

12. The system of claim 10, wherein the payment network is configured to assign at least a different part of the UAN to be consistent with a prior-assigned UAN for a payment account, the prior-assigned UAN included in a memory and associated with the second merchant.

13. The system of claim 10, wherein the payment network includes a database in the memory, the databased including multiple UANs each associated with a different merchant payment account; and
wherein the payment network is configured to retrieve the UAN from the database, based on the identifier included in the charge request.

14. The system of claim 10, further comprising the first merchant and a POS device associated with a first merchant; and
wherein the payment network is configured to receive the charge request from the POS device associated with the first merchant and report a balance associated with the payment account to the second merchant.

15. The system of claim 14, wherein the first merchant is a toll operator and the POS device is configured to read toll tags associated with vehicles in the vicinity of at least one of a bridge and a road associated with the toll operator; and
wherein the second merchant is a toll operator different than the first merchant.

16. A non-transitory computer readable storage media including executable instructions which, when executed by at least one processor, cause the at least one processor to:
receive a charge request for a transaction, the request including an identifier associated with a merchant payment account;
determine, based on the identifier, a uniform account number (UAN), the UAN being unique to the merchant payment account; and
alter a balance associated with the merchant payment account based on the charge request and the UAN.

17. The non-transitory computer readable storage media of claim 16, wherein the executable instructions, when executed by the at least one processor, cause the at least one processor to retrieve the UAN when the UAN is assigned with the identifier; and
wherein the executable instructions, when executed by the at least one processor, further cause the at least one processor to assign the UAN, based on the identifier, when no UAN is assigned to the identifier.

18. The non-transitory computer readable storage media of claim 17, wherein the executable instructions, when executed by the at least one processor, cause the at least one processor to calculate at least a MIN and a serial number of the UAN based on the identifier, in order to determine the UAN; and
wherein the MIN is unique to a first merchant, the first merchant being an issuer of the payment account.

19. The non-transitory computer readable storage media of claim 16, wherein the executable instructions, when executed by the at least one processor, cause the at least one processor to alter the balance associated with the merchant payment account when said account is managed by a service provider; and
wherein the executable instructions, when executed by the at least one processor, further cause the at least one processor to transmit a charge request and/or the UAN to an issuing merchant for the merchant payment account.
